(19) United States
(12) Patent Application Publication
(10) Pub. No.: US 2011/0179268 A1
(43) Pub. Date: Jul. 21, 2011

(54) PROTECTING APPLICATIONS WITH KEY AND USAGE POLICY

(75) Inventors: Clifford P. Strom, Sammamish, WA (US); Mark E. Paley, Redmond, WA (US); Suntian Song, Redmond, WA (US)

(73) Assignee: MICROSOFT CORPORATION, Redmond, WA (US)

(21) Appl. No.: 12/690,429

(22) Filed: Jan. 20, 2010

(51) Int. Cl. H04L 29/06; G06F 12/14; H04L 9/32

(52) U.S. Cl. 713/156; 713/189; 713/176; 713/168

(57) ABSTRACT

One or more files of an application are obtained and configured as a virtual storage volume. An application package is generated by encrypting, using a key, the one or more files configured as a virtual storage volume. A license generation module generates a license including both a usage policy for the application and the key. A computing device, to run the application, obtains and attempts to authenticate the application package. If the application package is authenticated, then a license associated with the application package is obtained and at least part of the application package is decrypted using the key in the license. A virtual storage volume that includes the application is mounted, and the application is executed in accordance with the usage policy in the license. However, if the application is not authenticated, then the application is not executed.

### BACKGROUND

As computers have become increasingly commonplace, a large number of different programs have become available for use on computers. This widespread use of computers and computer programs, however, has not come without its problems. One such problem is that sometimes the computer programs can be transferred and used on computers that do not have the right to do so. This can result in a loss to the computer program developer in light of the time and effort invested by the computer program developer in creating the program.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, an application package creation service obtains one or more files of an application and configures the one or more files as a virtual storage volume. The service generates an application package by encrypting, using an encryption key, the one or more files configured as a virtual storage volume. A license generation module is able to generate a license including both a usage policy for the application and the encryption key.

In accordance with one or more aspects, an application package including an encrypted application is obtained and an attempt is made to authenticate the application package. If the application package is authenticated, then a license associated with the application package is obtained and at least part of the application package is decrypted using a decryption key in the license. A virtual storage volume that includes the application is mounted, and the application is executed. However, if the application is not authenticated, then the application is not executed.

### BRIEF DESCRIPTION OF THE DRAWINGS

The same numbers are used throughout the drawings to reference like features.

FIG. 1 illustrates an example system implementing the protecting applications with a key and usage policy in accordance with one or more embodiments.

FIG. 2 illustrates an example application package creation service in accordance with one or more embodiments.

FIG. 3 illustrates an example application package and associated license in accordance with one or more embodiments.

FIG. 4 illustrates an example computing device in accordance with one or more embodiments.

FIG. 5 is a flowchart illustrating an example process for creating an application package in accordance with one or more embodiments.

FIG. 6 is a flowchart illustrating an example process for using an application package and associated license in accordance with one or more embodiments.

FIG. 7 illustrates an example computing device that can be configured to implement the protecting applications with a key and usage policy in accordance with one or more embodiments.

### DETAILED DESCRIPTION

Protecting applications with a key and usage policy is discussed herein. An application includes one or more files, and those one or more files are configured as a virtual storage volume and encrypted to form an application package. A license associated with the application package is also generated, the license including both the key used to encrypt the one or more files and a usage policy for the application. In order to execute the application, a computing device obtains and authenticates the application package. After the application package is authenticated, the computing device uses the key in the license to decrypt the application in the application package, and executes the application in accordance with the usage policy included in the license.

References are made herein to symmetric key cryptography, public key cryptography and public/private key pairs. Although such key cryptography is well-known to those skilled in the art, a brief overview of such cryptography is included here to assist the reader. In public key cryptography, an entity (such as a user, hardware or software component, a device, a domain, and so forth) has associated with it a public/private key pair. The public key can be made publicly available, but the entity keeps the private key a secret. Without the private key it is computationally very difficult to decrypt data that is encrypted using the public key. So, data can be encrypted by any entity with the public key and only decrypted by an entity with the corresponding private key. Additionally, a digital signature for data can be generated by using the data and the private key. Without the private key it is computationally very difficult to create a signature that can be verified using the public key. Any entity with the public key can use the public key to verify the digital signature by executing a suitable digital signature verification algorithm on the public key, the signature, and the data that was signed.

In symmetric key cryptography, on the other hand, a shared key (also referred to as a symmetric key) is known by and kept secret by the two entities. Data can be encrypted with the shared key using a suitable symmetric encryption algorithm, and any entity having the shared key is able to decrypt data encrypted with that shared key. Without the shared key it is computationally very difficult to decrypt data that is encrypted with the shared key. So, if two entities both know the shared key, each can encrypt data that can be decrypted by the other, but other entities cannot decrypt the data if the other entities do not know the shared key. Additionally, digital signatures can be generated based on symmetric key cryptography, such as using a keyed-hash message authentication code mechanism. Any entity with the shared key can generate and verify the digital signature. For example, a trusted third party can generate a symmetric key based on an identity of a particular entity, and then can both generate and verify digital signatures for that particular entity (e.g., by encrypting or decrypting the data using the symmetric key).

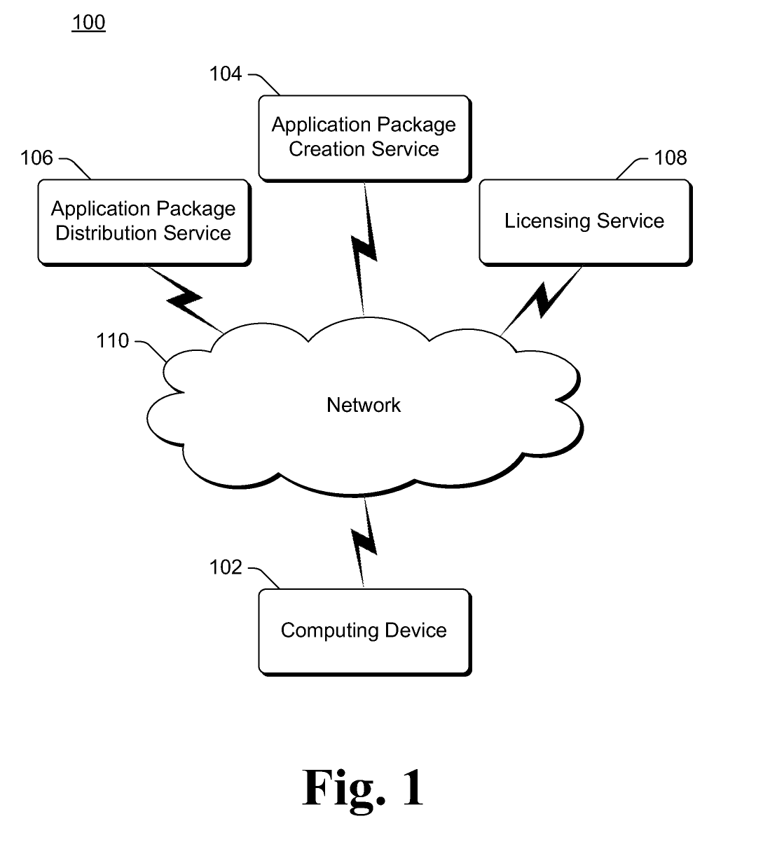

FIG. 1 illustrates an example system 100 implementing the protecting of applications with a key and usage policy in accordance with one or more embodiments. System 100 includes a computing device 102, an application package creation service 104, an application package distribution service 106, and a licensing service 108. Various ones of device 102 and services 104, 106, and 108 can communicate with one another via a network 110. Network 110 can be a variety of different networks, including the Internet, a local area network (LAN), a telephone network, an intranet, other public and/or proprietary networks, combinations thereof, and so forth. Although a single computing device 102, single application package creation service 104, single application package distribution service 106, and single licensing service 108 are illustrated in system 100, alternatively system 100 can include one or more devices 102, one or more application package creation services 104, one or more application package distribution services 106, and/or one or more licensing services 108.

Computing device 102 is typically used by a user to execute an application and/or perform other operations, and thus is also referred to as a user device. Computing device 102 can be a variety of different types of devices. For example, computing device 102 can be a desktop computer, a laptop or netbook computer, a mobile station, an entertainment appliance, a set-top box communicatively coupled to a display device, a television, a cellular or other wireless phone, a portable audio/video playback device, a game console, an automotive computer, and so forth. Thus, computing device 102 may range from a full resource device with substantial memory and processor resources (e.g., personal computers, game consoles) to a low-resource device with limited memory and/or processing resources (e.g., traditional set-top boxes, hand-held game consoles).

Services 104, 106, and 108 can each be implemented as one or more computing devices. Similar to the discussion of computing device 102, services 104, 106, and 108 can each be implemented using one or more of a variety of different types of devices, ranging from full resource devices with substantial memory and processor resources to low-resource devices with limited memory and/or processing resources. Additionally, although illustrated as separate services, it is to be appreciated that two or more of services 104, 106, and 108 can be combined into a single service. Furthermore, it is also to be appreciated that the functionality of one or more of services 104, 106, and 108 can be separated into multiple services.

Application package creation service 104 manages the creation of application packages. An application includes one or more files including data and/or instructions used in executing the application. These files are obtained by service 104 and configured as a virtual storage volume. These files, configured as a virtual storage volume, are then encrypted using an encryption key to form an application package. The encryption key is included in a license associated with the application package, as discussed in more detail below.

Application package distribution service 106 obtains the application packages from application package creation service 104 and manages the distribution of the application packages to computing devices, such as computing device 102. Service 106 can communicate an application package to computing device 102 via network 110, or alternatively via another communication medium. For example, service 106 can manage the sending of a disc including the application package to computing device 102. Alternatively, application packages can be communicated to computing device 102 from other sources, such as other user devices.

Application packages can be communicated to computing device 102 in response to a variety of different events. For example, an application package can be communicated to computing device 102 in response to a request for a particular application or application package from a user of device 102, a request from a module or component of computing device 102, a request from a user of application package distribution service 106, a request from another device, and so forth.

Licensing service 108 manages the distribution of licenses associated with application packages. The license can be generated by any of various entities that have the encryption key, such as licensing service 108. Each license includes both a usage policy that identifies one or more rights computing device 102 has regarding using the application in the application package associated with the license, and a decryption key. This decryption key is the same key as was used by application package creation service 104 to encrypt the one or more files of the application (or alternatively is a value from which the key used by service 104 to encrypt the one or more files can be derived). Different application packages are associated with different licenses, so computing device 102 can have different usage policies for different applications. The license, or portions thereof, is protected so that it can be used by computing device 102, or a set of multiple devices including computing device 102, but not by other devices. Accordingly, the license is referred to as targeting computing device 102 (and computing device 102 is referred to as the target device of the license).

The usage policy identifies one or more rights that a computing device has to the application, such as the right to run the application for an unlimited amount of time, the right to run the application for a limited amount of time or to run the application a limited number of times, the right to run only certain levels or portions of the application, and so forth. The particular usage policy in a license can be determined in a variety of different matters. Licensing service 108 can determine the usage policy for a license, or alternatively licensing service 108 can obtain an indication of the usage policy for a license from another device or service (e.g., from application package creation service 104). The usage policy can depend on, for example, whether an appropriate fee has been paid for particular rights, the desires of the author or developer of the application in the application package, the desires of an administrator of licensing service 108 and/or application package creation service 104, and so forth.

The license also includes an identifier of the application package and the symmetric key used to encrypt the one or more files in the application package. The identifier of the application package can be obtained in different manners, such as an identifier assigned by package creation module 204 or another module of service 200, an identifier generated by licensing service 108 (e.g., a hash value generated by applying a hash function to the one or more files), and so forth. The identifier is used to distinguish the application package from other application packages.

Licensing service 108 can communicate a license to computing device 102 in response to a variety of different events. For example, a license can be communicated to computing device 102 in response to a request for an application package from a user of device 102, in response to a request from application package distribution service 106, in response to a user request to run an application on computing device 102, and so forth.

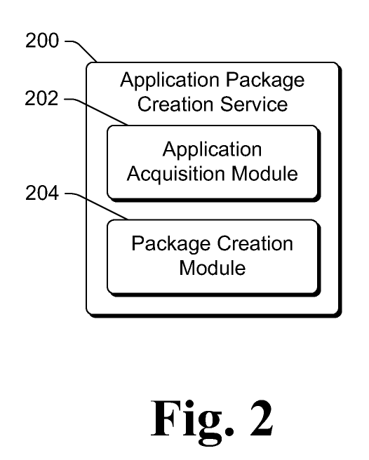

FIG. 2 illustrates an example application package creation service 200 in accordance with one or more embodiments. Application package creation service 200 can be, for example, service 104 of FIG. 1. Application package creation service 200 includes an application acquisition module 202 and a package creation module 204.

Application acquisition module 202 obtains one or more files of an application for which an application package is to be created. These one or more files are various files used in executing or running the application, such as files including data and/or instructions, and can include executable or binary files, image files, audio files, text files, setting or control information files, and so forth. Application acquisition module 202 can obtain the one or more files in one or more of a variety of different manners. For example, another device or module can send the one or more files to application acquisition module 202, application acquisition module 202 can access a remote device or module and retrieve the one or more files from that remote device or module, application acquisition module 202 can copy the one or more files from a disk, and so forth.

Package creation module 204 obtains the one or more files of the application from application acquisition module 202 and creates an application package for the application. Package creation module 204 configures the one or more files as a virtual storage volume that can be mounted as a storage volume by a file system of a computing device running the application. This configuration includes generating appropriate data structures and/or other information describing the organization of the one or more files on the virtual storage volume. This configuration also includes creating the appropriate integrity information (e.g., checksums or other integrity verification values) that allows the virtual storage volume to be authenticated on a segment-by-segment basis. Package creation module 204 also includes those data structures, integrity information, and/or other information in the application package. The running of the application by a computing device is discussed in more detail below.

Package creation module 204 also encrypts the one or more files in the application package. Module 204 uses a symmetric key, also referred to as the encryption key, and a symmetric encryption algorithm to encrypt the one or more files. Module 204 can generate the symmetric key in a variety of well-known manners, or alternatively can obtain the symmetric key from another component or module.

Package creation module 204 encrypts individual segments of the one or more files. Each of these segments refers to a portion of the virtual storage volume on which the one or more files are configured. These segments correspond to, for example, the disk blocks or sectors of a magnetic hard disk on which information is stored. Encrypting the individual segments of the one or more files allows a file system of a computing device running the application to obtain and decrypt individual segments of the virtual storage volume on a segment-by-segment basis.

In one or more embodiments, package creation module 204 also generates a digital signature by digitally signing at least part of the application package that module 204 is creating. This digital signature can be generated using a variety of different well known digital signature algorithms. This digital signature allows another device or service (e.g., computing device 102 or application package distribution service 106 of FIG. 1) to ensure that the application package created by module 204 was not altered after the digital signature was generated.

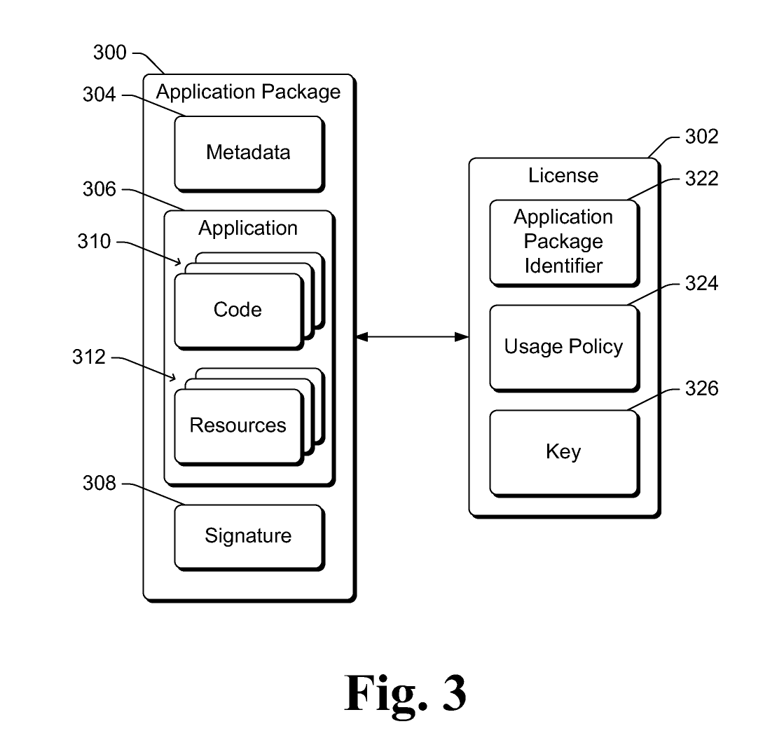

FIG. 3 illustrates an example application package and associated license in accordance with one or more embodiments. FIG. 3 illustrates an application package 300 and associated license 302. Application package 300 includes metadata 304, the application 306, and a signature 308. Application 306 is the encrypted one or more files of the application, and includes one or more code files 310 (e.g., files storing executables, files storing instructions, etc.) and one or more resource files 312 (e.g., files storing audio data, image data, setting information, etc.).

Metadata 304 includes various data or information regarding application 306 and/or application package 300. In one or more embodiments, metadata 304 includes an identifier of application package 300 (e.g., an identifier assigned to application package 300 by application package creation service 104 of FIG. 1). Metadata 304 can also include other data, such as a title or description of application 306, a thumbnail to be displayed to represent application 306, data structures and/or other information describing the organization of the one or more files on the virtual storage volume on which application 306 is configured, integrity information used to verify the integrity of application 306, and so forth.

Signature 308 is a digital signature generated by digitally signing at least part of application package 300. In one or more embodiments, application 306 is digitally signed to generate signature 308, although other portions (e.g., metadata 304) can also be digitally signed. Signature 308 can be generated using a variety of different well known public key or symmetric key cryptography digital signature algorithms. Signature 308 can be used by a computing device when running application 306 to ensure that application 306 (and/or other digitally signed portions of application package 300) has not been altered since signature 308 was generated. A single signature 308 can be generated over one or more portions of application package 300, or alternatively multiple signatures 308 over multiple portions of application package 300 can be generated and included in application package 300. For example, one signature 308 can be generated over metadata 304, and additional signatures 308 can be generated over one or more portions of code 310 and/or resources 312.

License 302 includes an application package identifier 322, a usage policy 324, and a key 326. Application package identifier 322 is an identifier of application package 300. This identifier can be, for example, the same identifier as is included in metadata 304 of application package 300. Application package identifier 322 identifies the application package that license 302 is associated with, and thus associates application package 300 and license 302.

Usage policy 324 identifies the rights that a computing device has to application 306. A variety of different rights, as discussed above, can be identified in usage policy 324. Key 326 is the symmetric key used to encrypt application 306.

Application 306 is encrypted, as discussed above. Accordingly, application package 300 can be distributed or communicated to arbitrary devices via arbitrary methods without any additional security precautions.

As discussed above, license 302 can be generated by the licensing service (e.g., licensing service 108 of FIG. 1). In such situations, the application package creation service (e.g., service 104 of FIG. 1) can communicate to the licensing service both the identifier of application package 300 and the key used to encrypt application 306. The key (and typically the identifier as well) is securely communicated to the licensing service in a variety of different manners (e.g., encrypting the key and identifier with a public key of the licensing service, establishing a secure communication channel based on a symmetric key, and so forth).

Alternatively, the key used to encrypt application 306 can be derived in a manner known by both the application package creation service and the licensing service. In such situations, the key need not be securely communicated between the application package creation service and the licensing service as each such service can independently derive the key. The key used to encrypt application 306 can be derived in different manners, such as by combining (or applying another function or algorithm to) application package identifier 322 and a shared secret (secret data) that is known only to license service 108 and application package creation service 104. Similarly, application package identifier 322 can be obtained or generated by the licensing service (obtained from the same source, or generated in the same manner, as the application package creation service).

In one or more embodiments care is taken to protect license 302 so that key 326 is not divulged to entities that are not entitled to retrieve it. License 302 can be protected in a variety of different manners. For example, license 302 (or portion thereof, such as key 326) can be encrypted using the public key of the computing device that is the target device of the license, using the public key of a set of computing devices that includes the target device of the license, license 302 can be communicated to a target device via a secure communication channel established based on a symmetric key, and so forth.

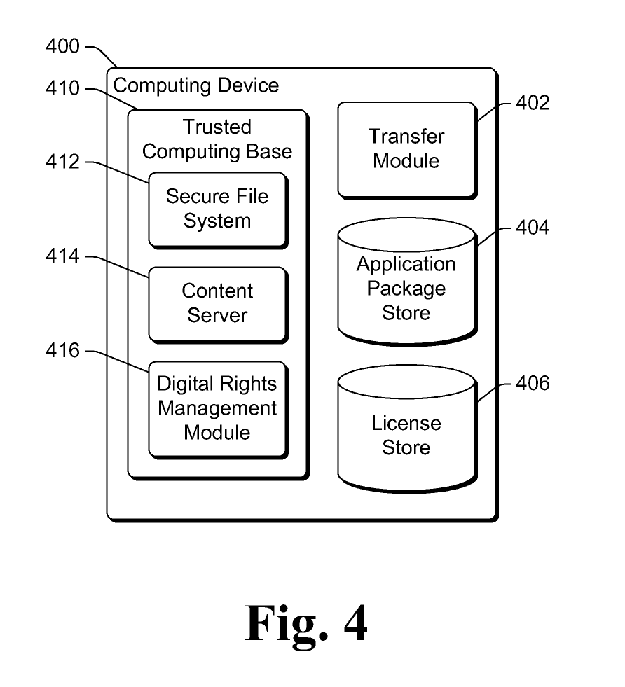

FIG. 4 illustrates an example computing device 400 in accordance with one or more embodiments. To run an application on computing device 400, the application package including the desired application is communicated to computing device 400. Different applications can be run on computing device 400, including applications that are downloaded to and installed on computing device 400, applications that are downloaded to computing device 400 but need not be installed on computing device 400, applications that are streamed to computing device 400, and so forth.

In one or more embodiments, computing device 400 includes a transfer module 402, an application package store 404 and a license store 406. Transfer module 402 manages the receipt of application packages communicated to computing device 400. The received application packages are stored in application package store 404. Although illustrated as part of computing device 400, application package store 404 can alternatively be implemented separately from computing device 400, such as on another device coupled to computing device 400 (e.g., via a network), on a removable device, and so forth.

Transfer module 402 also manages the receipt of licenses associated with application packages from a licensing service (e.g., licensing service 108 of FIG. 1) and storing of the licenses in license store 406. Although illustrated as part of computing device 400, license store 406 can alternatively be implemented separately from computing device 400, such as on another device coupled to computing device 400 (e.g., via a network), on a removable device, and so forth.

Application package store 404 and license store 406 can be implemented on a variety of different storage media. For example, stores 404 and 406 can be implemented on a magnetic disk, an optical disc, a solid state memory (e.g., Flash memory), and so forth.

Transfer module 402 can obtain a license for an application at a variety of different times. In one or more embodiments, the license associated with the application package (and thus the license associated with the application) is obtained from a licensing service when the application package is obtained. The license can be communicated to computing device 400 at the same time as the application package, optionally accompanying the application package, or alternatively at different times.

In other embodiments, the license associated with the application package is obtained from a licensing service in response to a request (e.g., from a user or other component or module) to run the application. Alternatively, the license associated with the application package is obtained from a licensing service at other times, such as prior to receiving the associated application package, in response to detecting an application package in application package store 404 that does not have an associated license in license store 406, and so forth.

The license associated with an application package is communicated to computing device 400 in a secure manner so that the key in the license is not divulged to entities that are not entitled to retrieve the key from the license. The license can be communicated to computing device 400 securely in a variety of different manners. In one or more embodiments, the licensing service encrypts the license using the public key of computing device 400. The license can then be communicated to computing device 400 and decrypted by computing device 400 using a private key of computing device 400, but cannot be decrypted by other devices that may obtain the license.

Alternatively, the license can be securely communicated to computing device 400 in different manners. For example, a secure communication channel based on a symmetric key can be established between the licensing service and computing device 400. The license can be communicated from the licensing service to computing device 400 using this secure communication channel rather than being encrypted with the public key of computing device 400.

Computing device 400 includes a trusted computing base (TCB) 410, which includes a secure file system 412, content server 414, and a digital rights management (DRM) module 416. Digital rights management module 416 enforces on computing device 400 the usage policy identified in the licenses in license store 406. Although illustrated as being included in trusted computing base 410, digital rights management module 416 and trusted computing base 410 can alternatively be separate components. Digital rights management module 416 can also forward information regarding the usage policy to the application itself for the application to enforce at least part of the usage policy. For example, an indication of limited functionality that the usage policy allows (such as restricting access to particular levels or other functionality of the application) can be provided to the application so that the application itself can prevent access to the restricted functionality.

A request to run an application can be received by trusted computing base 410 in a variety of different manners, such as a user input or a request from another component or module. In response to a request to run an application, trusted computing base 410 notifies digital rights management module 416 of the request. Digital rights management module 416 attempts to obtain a license associated with the application. Module 416 can obtain the associated license from license store 406, or alternatively can obtain the associated license from the licensing service. In one or more embodiments, digital rights management module 416 first checks license store 406 for a license associated with the application package and uses such license if found in store 406. If no such license is found in store 406, then digital rights management module 416 requests such a license from a licensing service (e.g., licensing service 108 of FIG. 1). This request for the license from the licensing service can optionally involve additional user input, such as user permission to access the licensing service, user permission to purchase a license from the licensing service, and so forth.

If digital rights management module 416 is able to obtain a license associated with the application package that includes the application, then digital rights management module 416 and trusted computing base 410 permit running of the application on computing device 400 in accordance with the usage policy in the license associated with the application package. If digital rights management module 416 is not able to obtain a license associated with the application package that includes the application, then digital rights management module 416 prohibits running of the application on computing device 400. However, if digital rights management module 416 were able to obtain a license associated with the application package that includes the application at a later time, then digital rights management module 416 permits running of the application on computing device 400 at that later time in accordance with the usage policy in the license associated with the application package.

Content server 414 manages the running of the application on computing device 400. In one or more embodiments, computing device 400 supports a system architecture where individual components (such as a running application, trusted computing base 410, digital rights management module 416, etc.) execute in protected or isolated areas of memory. The system architecture prohibits the individual components from accessing the memory area of a different individual component. The individual components can submit requests to different components and receive responses from different components, but are restricted from directly accessing the memory area of another component.

To run an application, trusted computing base 410 obtains an area of memory (e.g., from a memory manager component (not shown)) in which the application can be run. One or more files to be run for the application are obtained from secure file system 412 and loaded into the memory area for the application. The particular file or files to be run and/or other operations to be performed to install the application can be identified as part of the application package (e.g., in metadata of the application package) or alternatively elsewhere. While the application is running, requests for additional files can be received by content server 414 from the application.

Secure file system 412 manages interaction with the one or more files of the application as encrypted in the application package. To run the application, secure file system 412 mounts a new virtual storage volume for computing device 400. This new virtual storage volume is the virtual storage volume for which the one or more files are configured as discussed above. The one or more encrypted files in the application package are the information stored on the virtual storage volume. Additional data structures and/or other information describing the organization of the one or more files on the virtual storage volume can also be stored on the virtual storage volume and used by secure file system 412 in accessing the virtual storage volume. Secure file system 412 receives a request for an individual one (or portions thereof) of the one or more files from content server 414, and identifies the appropriate encrypted segments that store that individual file. These requests can be requests from content server 414 to begin running the application, or requests received by content server 414 while the application is running.

Secure file system 412 retrieves the encrypted segments in which the individual file is stored and decrypts those segments. This decryption is performed on a segment-by-segment basis, with individual segments being decrypted as they are requested. Secure file system 412 can also optionally decrypt and cache one or more segments in anticipation of such segments being requested. This decryption is performed using a symmetric key, also referred to as the decryption key, and a symmetric decryption algorithm. The decryption key is the same key as was used as the encryption key by the application package creation service to encrypt the segments, and the symmetric decryption algorithm is the decryption algorithm corresponding to the encryption algorithm used by the application package creation service to encrypt the segments. This key is stored in the license associated with the application package as discussed above.

Thus, it can be seen that the applications remain protected from being run by entities that do not have the rights to do so, and that the desired rights for the applications are enforced by computing device 400. An individual application need have no knowledge of how the application is encrypted or otherwise protected, or even whether the application is encrypted or otherwise protected. Rather, when running the application simply requests the appropriate files or portions thereof from content server 414, and the application is shielded from any knowledge of the decryption performed by secure file system 412. The security of the techniques discussed herein is provided by the platform or system of computing device 400 (e.g., trusted computing base 410 and digital rights management module 416) rather than the individual applications.

It should also be noted that in one or more embodiments the application is fully encrypted in the application package. Both data and instruction files are encrypted in the application package. Alternatively, one or more files could be left unencrypted if desired.

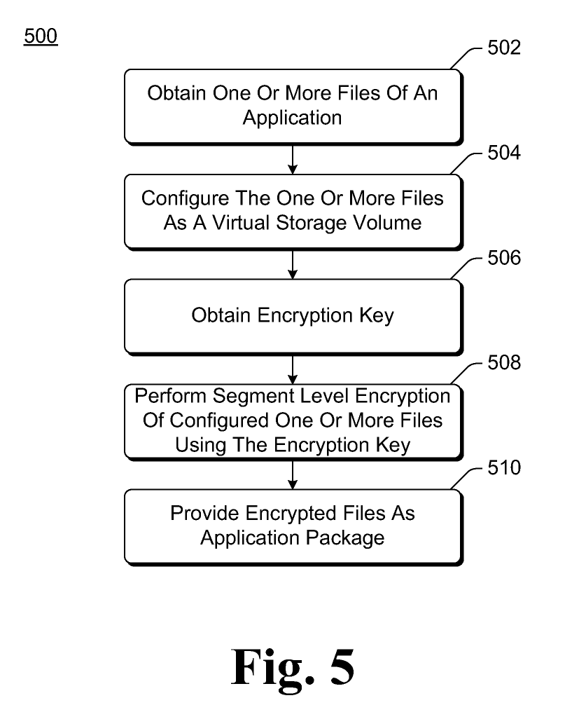

FIG. 5 is a flowchart illustrating an example process 500 for creating an application package in accordance with one or more embodiments. Process 500 is carried out by an application package creation service, such as service 104 of FIG. 1, and can be implemented in software, firmware, hardware, or combinations thereof. Process 500 is shown as a set of acts and is not limited to the order shown for performing the operations of the various acts. Process 500 is an example process for creating an application package; additional discussions of creating an application package are included herein with reference to different figures.

In process 500, one or more files of an application are obtained (act 502). These one or more files can be obtained in a variety of different manners and via a variety of different communication media as discussed above. These one or more files can be, for example all of the data and instructions used in executing the application.

The one or more files are configured as a virtual storage volume (act 504). This configuring of the one or more files allows each application to be mounted and accessed as its own virtual storage volume or virtual disk.

An encryption key is obtained (act 506). This encryption key is a symmetric key and can be generated or obtained in different manners as discussed above.

The one or more files, configured as the virtual storage volume, are encrypted at a segment level using the obtained encryption key (act 508). This segment level refers to encrypting the segments (e.g., disk blocks or sectors) of the virtual storage volume individually.

The encrypted files are provided as an application package (act 510). The application package can also include additional information, such as metadata and a digital signature as discussed above. The application can be provided to various computing devices as discussed above.

Additionally, a license generation module can generate a license associated with the application package as discussed above. The license generation module can be included as part of the application creation service, or alternatively as part of another service (e.g., as part of a licensing service). The application package creation service can provide the encryption key to the license generation module, or alternatively the application package creation service and license generation module can independently derive the encryption key as discussed above.

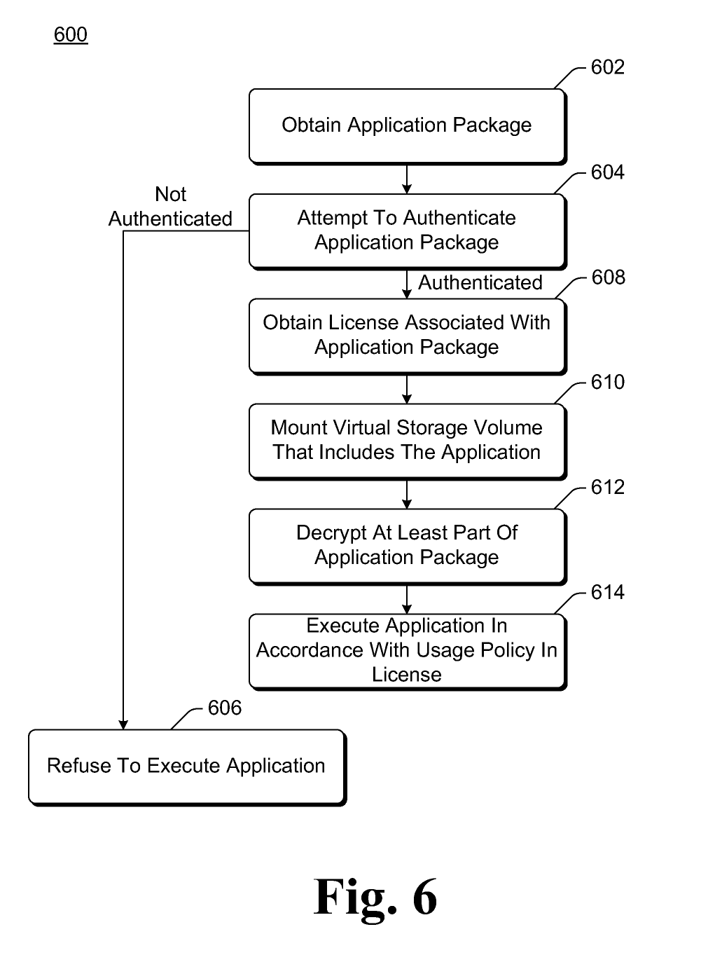

FIG. 6 is a flowchart illustrating an example process 600 for using an application package and associated license in accordance with one or more embodiments. Process 600 is carried out by a computing device on which running of an application is requested, such as computing device 102 of FIG. 1, and can be implemented in software, firmware, hardware, or combinations thereof. Process 600 is shown as a set of acts and is not limited to the order shown for performing the operations of the various acts. Process 600 is an example process for using an application package and associated license; additional discussions of using an application package and associated license are included herein with reference to different figures.

In process 600, an application package is obtained (act 602). The application package can be communicated to the device implementing process 600 in a variety of different manners as discussed above. The application package can be obtained, for example, in response to a request to run the application in the application package, or alternatively can be obtained prior to receiving a request to run the application.

An attempt to authenticate the application package is made (act 604). This attempted authentication comprises, for example, using a digital signature included in the application package to verify that the application package has not been changed since the digital signature was generated.

If the application package is not authenticated, then the device refuses to execute the application (act 606). However, a new application package that can be authenticated can be obtained by the device, in response to which the application could be executed (assuming an associated license permitted its execution).

Although illustrated as a single act, the attempt to authenticate the application package can be made at different times. For example, an authentication of an initial portion of the application package (e.g., authentication of the metadata in the application package) can initially be made in act 606. As subsequent portions of the application (e.g., code and/or resource portions) are accessed in executing the application, integrity information included in the metadata can be used to validate those subsequent portions. Alternatively, additional signatures generated by digitally signing the subsequent portions can be authenticated as the subsequent portions are accessed in executing the application. If a subsequent portion is not authenticated while an application is executing, then the device refuses to continue executing the application.

If the application package is authenticated, then a license associated with the application package is obtained (act 608). The license can be obtained from a local license store of the device implementing process 600, or from a remote licensing service.

A virtual storage volume that includes the application is mounted (act 610). This virtual storage volume is mounted by the file system of the device implementing process 600. As discussed above, the application package includes the appropriate data structures and/or other information describing the organization of the one or more files so that the file system can mount the virtual storage volume.

At least part of the application package is decrypted (act 612). One or more files of the application package are decrypted, as discussed above, using the key included in the license obtained in act 608.

The application is executed in accordance with the usage policy in the license associated with the application package (act 614). Various restrictions on the execution of the application can be imposed by the usage policy, as discussed above.

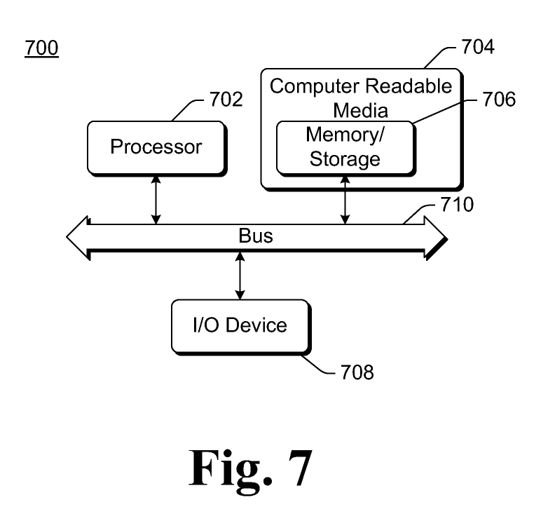

FIG. 7 illustrates an example computing device 700 that can be configured to implement the protecting applications with a key and usage policy in accordance with one or more embodiments. Computing device 700 can be, for example, computing device 102 of FIG. 1, computing device 400 of FIG. 4, or can implement at least part of service 200 of FIG. 2 or a service 104, 106, or 108 of FIG. 1.

Computing device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or one or more I/O devices 708 can be included as part of, or alternatively may be coupled to, computing device 700. Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 702. It is to be appreciated that different instructions can be stored in different components of computing device 700, such as in a processing unit 702, in various cache memories of a processing unit 702, in other cache memories of device 700 (not shown), on other computer readable media, and so forth. Additionally, it is to be appreciated that the location where instructions are stored in computing device 700 can change over time.

One or more input/output devices 708 allow a user to enter commands and information to computing device 700, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 7. The features of the protecting applications with a key and usage policy techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in an application package creation service, the method comprising:
obtaining one or more files of an application;
configuring the one or more files as a virtual storage volume; and
generating an application package by encrypting, using an encryption key, the one or more files configured as a virtual storage volume, wherein a license generation module can generate a license including both a usage policy for the application and the encryption key.

2. A method as recited in claim 1, wherein the license generation module is included as part of a licensing service separate from the application package creation service, the method further comprising securely communicating both the encryption key and an identifier of the application package to the license generation module for inclusion in the license.

3. A method as recited in claim 1, wherein the license generation module is included as part of a licensing service separate from the application package creation service, and wherein the application package creation service and the license generation module independently derive the encryption key based on a shared secret.

4. A method as recited in claim 1, the encrypting the one or more files comprises encrypting individual segments of each of the one or more files, each individual segment being a disk block on which at least part of one of the one or more files is stored.

5. A method as recited in claim 1, further comprising generating a digital signature by digitally signing the encrypted one or more files, and including the digital signature in the application package.

6. A method as recited in claim 5, wherein the digitally signing comprises digitally signing both metadata included in the application package and the encrypted one or more files, the metadata including an identifier of the application package.

7. A method as recited in claim 1, wherein the encryption key associates the license with the application package.

8. A method as recited in claim 1, wherein the one or more files of the application include data and instructions used in executing the application.

9. A method as recited in claim 1, wherein generating the application package further comprises:
generating an identifier of the application package;
including the identifier of the application package in the application package;
generating a digital signature by digitally signing the encrypted one or more files; and
including the digital signature in the application package.

10. One or more computer storage media having stored thereon multiple instructions, execution of which, by one or more processors of a computing device, causes the one or more processors to:
obtain an application package including an encrypted application;
attempt to authenticate the application package;
if the application package is authenticated, then:
obtain a license associated with the application package,
mount a virtual storage volume that includes the application,
decrypt at least part of the application package using a decryption key in the license, and
execute the application; and
if the application is not authenticated, then refuse to execute the application.

11. One or more computer storage media as recited in claim 10, wherein to attempt to authenticate the application package is to verify a digital signature in the application package, the digital signature having been generated by digitally signing one or more files of the application in the application package.

12. One or more computer storage media as recited in claim 10, wherein to execute the application is to execute the application in accordance with a usage policy included in the license.

13. One or more computer storage media as recited in claim 10, wherein the license associated with the application package includes a first application package identifier that is the same as a second application package identifier included in the application package.

14. One or more computer storage media as recited in claim 10, wherein to obtain the license is to obtain an encrypted license from a licensing service, and retrieve the license by decrypting the encrypted license using a private key of the computing device.

15. One or more computer storage media as recited in claim 10, wherein to decrypt at least part of the application package is to decrypt individual segments of the virtual storage volume on a segment-by-segment basis.

16. One or more computer storage media as recited in claim 15, wherein execution of the multiple instructions further causes the one or more processors to:
receive from the application, while the application is executing, a request for data;
identify one or more segments of the virtual storage volume in which the data is stored;
decrypt the identified one or more segments; and
return the data in the one or more decrypted segments to the application.

17. One or more computer storage media as recited in claim 10, wherein the decryption key associates the license with the application package.

18. One or more computer storage media as recited in claim 10, wherein the application executes in an isolated area of memory that other applications are restricted from accessing.

19. One or more computer storage media as recited in claim 10, wherein the application package includes:
the encrypted application;
metadata including an identifier of the application package; and
a digital signature having been generated by digitally signing the identifier of the application package and the encrypted application.

20. A method in a computing device, the method comprising:
obtaining an application package from an application package distribution service, the application package including:
an encrypted application,
metadata including an identifier of the application package, and
a digital signature generated by digitally signing the identifier of the application package and the encrypted application;
attempting to authenticate the application package by verifying the digital signature in the application package;
if the application package is authenticated, then:
obtaining a license associated with the application package, the license including a decryption key and usage policy,
mounting a virtual storage volume that includes the application,
decrypting at least part of the application package using the decryption key in the license, and
executing the application in accordance with the usage policy, and decrypting and returning to the application one or more additional parts of the application package in response to requests for data from the application; and
if the application is not authenticated, then refusing to execute the application.
